(19) United States
(12) Patent Application Publication
(10) Pub. No.: US 2017/0171579 A1
(43) Pub. Date: Jun. 15, 2017

(54) Method and Device for Transcoding Live Video

(71) Applicants: Le Holdings (Beijing) Co., Ltd., Beijing (CN); LeCloud Computing Co., Ltd., Beijing (CN)

(72) Inventors: Fengyu Liu, Beijing (CN); Zhengyu Lin, Beijing (CN); Maosheng Bai, Beijing (CN)

(21) Appl. No.: 15/246,418

(22) Filed: Aug. 24, 2016

Related U.S. Application Data
(63) Continuation of application No. PCT/CN2016/088875, filed on Jul. 6, 2016.

(30) Foreign Application Priority Data
Dec. 14, 2015 (CN) 201510926568.0

(51) Int. Cl. H04N 21/2343; H04N 21/2387; H04N 21/84; H04L 29/06; H04N 21/434; H04N 21/2187; H04N 21/472

(52) U.S. Cl. CPC H04N 21/234309; H04N 21/2187; H04N 21/2387; H04N 21/47217; H04L 65/602; H04N 21/4345; H04N 21/84

(57) ABSTRACT

Disclosed are a method and an electronic device for transcoding a live video. The method includes: receiving a streaming media data uploading request sent by a main playback user, wherein the streaming media data uploading request carries streaming media data and attribute information of the main playback user; selecting a real-time transcoding server according to the attribute information of the main playback user; and sending the streaming media data to the real-time transcoding server so that the real-time transcoding server converts in real time the streaming media data into multi-rate streaming media data, and sending the multi-rate streaming media data to a source server, wherein the real-time transcoding server and the source server are in the same distributed deployment.

### CROSS REFERENCE TO RELATED APPLICATIONS

This application is a continuation of International Application No. PCT/CN2016/088875, filed on Jul. 6, 2016, which is based upon and claims priority to Chinese Patent Application No. 201510926568.0, filed on Dec. 14, 2015, the entire contents of all of which are incorporated herein by reference.

### TECHNICAL FIELD

The present disclosure relates to computer technologies, and more particularly, to a method and an electronic device for transcoding a live video.

### BACKGROUND

Since it is carried out through an Internet platform, network broadcast provides better initiative operation for the masses than conventional broadcast, namely, providing better and freer choice space. For example, in popular live ball games, live sports, live weddings, live opening ceremonies and so on at present, to provide convenience for the masses, signals are published over the Internet so that audiences may conveniently choose required live broadcast lines to watch online live broadcast at any place where Internet is available across the globe. One implementation of network broadcast is mainly as below: a main playback user makes streaming media data used for live video broadcasting and then uploads the streaming media data into a live broadcasting platform via the network; and when a user requests to watch the live video, the streaming media data of the live video are sent by a resource server in the live broadcasting platform to the user. However, in order to adapt to demands of clients having multiple terminals and multiple screens for video code rates, video code rates pushed by the main playback user need to be transcoded to meet requirements of different users for playing live videos.

At present, when users watch live videos, transcoding of streaming media data is completed by stream pushing devices, and the transcoded streaming media data are pushed onto source servers by the stream pushing devices. However, the stream pushing devices can only push single-path streaming media data onto source servers, namely, the stream pushing devices can only convert streaming media data into a unified code rate issued by a cloud live broadcasting platform. For this reason, such live videos are difficult to adapt to demands of different player terminals for code rates.

### SUMMARY

The present disclosure provides a method and an electronic device for transcoding a live video, which are mainly aimed at solving a problem that transcoded live videos are difficult to adapt to demands of different player terminals for code rates.

In order to achieve the foregoing objective, the present disclosure mainly provides the following technical solution.

In a first aspect, embodiments of the present disclosure provide a method for transcoding a live video, implemented by a server, including:

receiving a streaming media data uploading request sent by a main playback user, where the streaming media data uploading request carries streaming media data and attribute information of the main playback user;

selecting a real-time transcoding server according to the attribute information of the main playback user; and

sending the streaming media data to the real-time transcoding server so that the real-time transcoding server converts in real time the streaming media data into multi-rate streaming media data, and send the multi-rate streaming media data to a source server, where the real-time transcoding server and the source server are in a distributed deployment.

In a second aspect, embodiments of the present disclosure provide a non-transitory computer-readable storage medium storing executable instructions that, when executed by an electronic device, cause the electronic device to perform any methods for transcoding a live video mentioned by embodiments of the present disclosure.

In a third aspect, embodiments of the present disclosure provide an electronic device, including: at least one processor; and a memory communicably connected with the at least one processor for storing instructions executable by the at least one processor, wherein execution of the instructions by the at least one processor causes the at least one processor to perform any methods for transcoding a live video mentioned by embodiments of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for transcoding a live video in accordance with some embodiments;

FIG. 2 is a flow chart of another method for transcoding a live video in accordance with some embodiments;

FIG. 3 is a structural block diagram showing composition of an apparatus for transcoding a live video in accordance with some embodiments;

FIG. 4 is a structural block diagram showing composition of another apparatus for transcoding a live video in accordance with some embodiments;

FIG. 5 is a schematic structural diagram of a server in accordance with some embodiments; and

FIG. 6 is a block diagram of an electronic device which is configured to perform the methods for transcoding a live video in accordance with some embodiments.

### DETAILED DESCRIPTION

To make the objectives, technical solutions, and advantages of the embodiments of the present disclosure clearer, the following clearly and completely describes the technical solutions in the embodiments of the present disclosure with combination of the accompanying drawings in the embodiments of the present disclosure. Apparently, the described embodiments are some but not all of the embodiments of the present disclosure.

Embodiments of the present disclosure provide a method for transcoding a live video, as shown in FIG. 1, the method specifically includes following steps.

101: A streaming media data uploading request sent by a main playback user is received.

The streaming media data uploading request carries streaming media data and attribute information of the main playback user, and the streaming media data can be data available for live broadcasting. The attribute information of the main playback user specifically can be information such as IP information, domain name information, location information, a data transfer rate and so on of the main playback user, which is not specifically limited in the embodiments of the present disclosure.

To the embodiments of the present disclosure, the streaming media data uploading request further can carry a code rate requested by the main playback user to convert, and the code rate specifically can be 1080p, 720 p, 1280 p, 1024 p or the like, which is not specifically limited in the embodiments of the present disclosure. It is to be noted that if the main playback user does not specify a code rate into which streaming media data are converted, the streaming media data are converted into a default code rate, where the default code rate can be any one of all code rates of live videos or can be a code rate configured by a system by default, which is not specifically limited in the embodiments of the present disclosure.

102: A real-time transcoding server is selected according to the attribute information of the main playback user.

To the embodiments of the present disclosure, a specific process of selecting a real-time transcoding server according to the attribute information of the main playback user can be as below: first of all, a streaming media data uploading request sent by the main playback user is parsed to acquire information such as operator information, location information, a transfer rate and so on of the main playback user from a parsed result, afterwards real-time transcoding servers identical to those of the operator of the main playback user are selected, then real-time transcoding servers that can transcode the location information of the main playback user are extracted from the real-time transcoding servers identical to those of the operator of the main playback user. In such a case, if there are a plurality of real-time transcoding servers that can transcode the location information of the main playback user, it is also required to further acquire load information of the real-time transcoding servers that can transcode the location information of the main playback user, and at last a real-time transcoding server having a larger load is selected therefrom. To the embodiments of the present disclosure, the real-time transcoding server can transcode in real time streaming media data into multi-rate streaming media data to adapt to demands of different player terminals for code rates.

103: The streaming media data are sent to the real-time transcoding server so that the real-time transcoding server converts in real time the streaming media data into multi-rate streaming media data.

Further, the real-time transcoding server sends the multi-rate streaming media data onto a source server. Both the real-time transcoding server and the source server are in a distributed deployment. For example, both the real-time transcoding server and the source server are deployed for a same operator in a same region. Multi-rate streaming media data in the real-time transcoding server can be rapidly sent to the source server if the real-time transcoding server and the source server adopt the same distributed deployment. It is to be noted that if real-time transcoding servers are in distributed deployment, each location area includes one or more real-time transcoding servers, and each real-time transcoding server corresponds to one location area, namely, each real-time transcoding server can only transcode streaming media data within its location area.

Further, after the real-time transcoding server converts the streaming media data into multi-rate streaming media data, also it can be determined whether a format of the streaming media data is a standard video format. If the format of the streaming media data is not a standard video format, the streaming media data needs to be converted into a standard video format, and then the multi-rate streaming media data having a standard format are sent to the source server. A standard video format refers to a common format that can be played by a player, for example, rmvb, wmv and avi or the like, which is not specifically limited in the embodiments of the present disclosure.

In the embodiments of the present disclosure, a real-time transcoding server closest to a main playback user server is selected according to attribute information of a main playback user in a received streaming media data uploading request, then streaming media data are converted into multi-rate streaming media data by means of the real-time transcoding server, and at last the multi-rate streaming media data are sent to a source server, thereby solving the problem that live videos are difficult to adapt to demands of different player terminals for code rates.

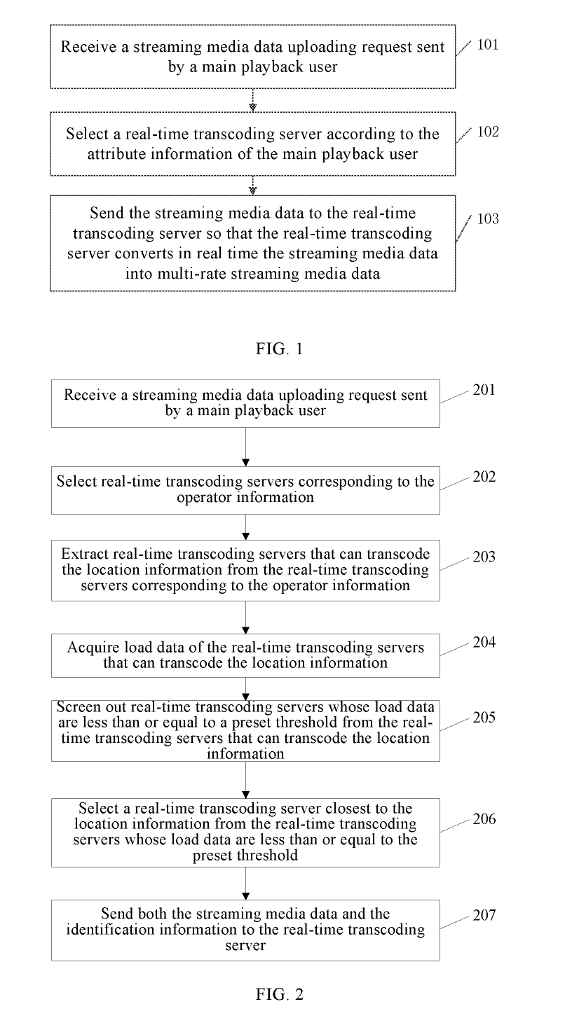

Corresponding to the foregoing method, embodiments of the present disclosure further provide a method for transcoding a live video, as shown in FIG. 2, the method specifically includes following steps.

201: A streaming media data uploading request sent by a main playback user is received.

The streaming media data uploading request carries streaming media data and attribute information of the main playback user. To the embodiments of the present disclosure, the attribute information of the main playback user includes location information, operator information and identification information, where the location information is used for representing a geographical location of the main playback user, and the operator information represents a network operator selected by the main playback user, specifically including China Unicom, China Telecom, China Mobile and so on, which is not specifically limited in the embodiments of the present disclosure. The identification information is information that is intended to be identified on a live video by the main playback user, for example, the identification information specifically can be a TV station caption, graphic icons and text icons, etc. In the embodiments of the present disclosure, by adding identification information into a streaming media data uploading request, the identification information can be displayed on a live video when a user requests to play the live video.

202: Real-time transcoding servers corresponding to the operator information are selected.

For example, if the operator of the main playback user is China Telecom, all real-time transcoding servers whose operator is China Telecom are selected from real-time transcoding servers in distributed deployment. In the embodiments of the present disclosure, servers of the same operator have a higher transfer rate. Therefore, by selecting real-time transcoding servers corresponding to operator information, in subsequent steps, the transfer rate of streaming media data transmitted between a main playback user server and a real-time transcoding server can be improved.

203: Real-time transcoding servers that can transcode the location information are extracted from the real-time transcoding servers corresponding to the operator information.

To the embodiments of the present disclosure, a specific process of extracting real-time transcoding servers that can transcode the location information can be as below: first of all, a location area where the location information is is acquired, then real-time transcoding servers within the location area are extracted from the real-time transcoding servers corresponding to the operator information.

For example, if location information of the main playback user is No. 123, Zhongshan Road, Heping District, since a location area corresponding to the location information is Heping District, and all real-time transcoding servers within Heping District can transcode streaming media data in the foregoing location information, a demand of transcoding streaming media data uploaded by the main playback user can be met by extracting the real-time transcoding servers that can transcode the location information from the real-time transcoding servers corresponding to the operator information.

204: Load data of the real-time transcoding servers that can transcode the location information are acquired.

The load data of the real-time transcoding servers represent a data size that can be borne by the real-time transcoding servers. In the embodiments of the present disclosure, by acquiring load data of the real-time transcoding servers that can transcode the location information, in subsequent steps, real-time transcoding servers can be effectively selected according to a principle of load equalization, thereby improving a transcoding efficiency and a utilization ratio of each real-time transcoding server.

205: Real-time transcoding servers whose load data are less than or equal to a preset threshold are screened out from the real-time transcoding servers that can transcode the location information.

The preset threshold can be set according to actual load conditions of each real-time transcoding server or can be configured by default by a system, which is not specifically limited in the embodiments of the present disclosure. In the embodiments of the present disclosure, real-time transcoding servers whose load data are less than or equal to the preset threshold are screened out from the real-time transcoding servers that can transcode the location information, and streaming media data are transcoded by means of the real-time transcoding servers whose load data are less than or equal to the preset threshold. In this way, the transcoding efficiency and the utilization ratio of each real-time transcoding server can be improved.

206: A real-time transcoding server closest to the location information is selected from the real-time transcoding servers whose load data are less than or equal to the preset threshold.

207: Both the streaming media data and the identification information are sent to the real-time transcoding server.

Further, the real-time transcoding server converts in real time the streaming media data into multi-rate streaming media data, and adds the identification information onto the multi-rate streaming media data. The multi-rate streaming media data are sent to a source server, where the real-time transcoding server and the source server are in the same distributed deployment.

According to the embodiments of the present disclosure, first of all, a streaming media data uploading request sent by a main playback user is received, real-time transcoding servers corresponding to the operator information are selected, afterwards real-time transcoding servers that can transcode the location information are extracted from the real-time transcoding servers corresponding to the operator information, then load data of the real-time transcoding servers that can transcode the location information are acquired, real-time transcoding servers whose load data are less than or equal to a preset threshold are screened out from the real-time transcoding servers that can transcode the location information, then a real-time transcoding server closest to the location information is selected from the real-time transcoding servers whose load data are less than or equal to the preset threshold, and at last both the streaming media data and the identification information are sent to the real-time transcoding server so that the real-time transcoding server converts in real time the streaming media data into multi-rate streaming media data, and adds the identification information onto the multi-rate streaming media data. In this way, a problem that in the prior art live videos are difficult to adapt to demands of different player terminals for code rates is solved.

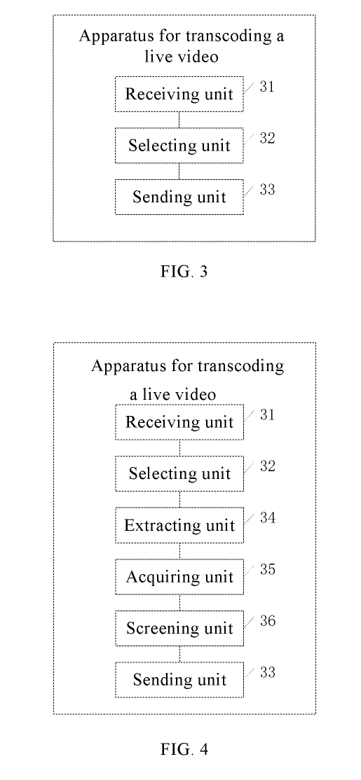

Further, as an implementation of the foregoing method, embodiments of the present disclosure provide an apparatus for transcoding a live video, as shown in FIG. 3, the apparatus includes: a receiving unit, a selecting unit and a sending unit.

The receiving unit 31 is configured to receive a streaming media data uploading request sent by a main playback user, where the streaming media data uploading request carries streaming media data and attribute information of the main playback user. The attribute information of the main playback user specifically can be information such as IP information, domain name information, location information, and a data transfer rate or the like of the main playback user.

The selecting unit 32 is configured to select a real-time transcoding server according to the attribute information of the main playback user received by the receiving unit 31 A specific process of selecting a real-time transcoding server according to the attribute information of the main playback user can be as below: first of all, a streaming media data uploading request sent by the main playback user is parsed to acquire information such as operator information, location information, a transfer rate and so on of the main playback user from a parsed result, afterwards real-time transcoding servers identical to those of the operator of the main playback user are selected, then real-time transcoding servers that can transcode the location information of the main playback user are extracted from the real-time transcoding servers identical to those of the operator of the main playback user. In such a case, if there are a plurality of real-time transcoding servers that can transcode the location information of the main playback user, it is also required to further acquire load information of the real-time transcoding servers that can transcode the location information of the main playback user, and at last a real-time transcoding server having a larger load is selected therefrom. To the embodiments of the present disclosure, the real-time transcoding server can transcode in real time streaming media data into multi-rate streaming media data to adapt to demands of different player terminals for code rates.

The sending unit 33 is configured to send the streaming media data to the real-time transcoding server selected by the selecting unit 32 so that the real-time transcoding server converts in real time the streaming media data into multi-rate streaming media data, and send the multi-rate streaming media data onto a source server. The real-time transcoding server and the source server are in a distributed deployment. Multi-rate streaming media data in the real-time transcoding server can be rapidly sent to the source server if the real-time transcoding server and the source server adopt the distributed deployment.

Further, as shown in FIG. 4, the attribute information of the main playback user includes operator information.

The selecting unit 32 is specifically configured to select real-time transcoding servers corresponding to the operator information received by the receiving unit 31.

Further, the attribute information of the main playback user further includes location information, and the apparatus further includes:

an extracting unit 34, configured to extract real-time transcoding servers that can transcode the location information from the real-time transcoding servers corresponding to the operator information selected by the selecting unit 32.

Further, the apparatus further includes:

an acquiring unit 35, configured to acquire load data of the real-time transcoding servers that can transcode the location information extracted by the extracting unit 34; and

a screening unit 36, configured to screen out real-time transcoding servers whose load data are less than or equal to a preset threshold from the real-time transcoding servers that can transcode the location information acquired by the acquiring unit 35.

The selecting unit 32 is specifically configured to select a real-time transcoding server closest to the location information from the real-time transcoding servers whose load data are less than or equal to the preset threshold screened out by the screening unit 36. The preset threshold can be set according to actual load conditions of each real-time transcoding server or can be configured by default by a system, which is not specifically limited in the embodiments of the present disclosure.

Further, when the streaming media data uploading request further carries identification information,

the sending unit 33 is specifically configured to send the streaming media data received by the receiving unit 31 and the identification information to the real-time transcoding server so that the real-time transcoding server converts in real time the streaming media data into multi-rate streaming media data, and adds the identification information onto the multi-rate streaming media data. The multi-rate streaming media data are sent to a source server, where the real-time transcoding server and the source server are in the same distributed deployment.

In conclusion, according to a method and an apparatus for transcoding a live video provided by the embodiments of the present disclosure, first of all, a streaming media data uploading request sent by a main playback user is received, where the streaming media data uploading request carries streaming media data and attribute information of the main playback user, then a real-time transcoding server is selected according to the attribute information of the main playback user, the streaming media data are sent to the real-time transcoding server so that the real-time transcoding server converts in real time the streaming media data into multi-rate streaming media data, and the multi-rate streaming media data are sent onto a source server, where the real-time transcoding server and the source server are in an identical distributed deployment. Compared with a fact that at present a stream pushing device merely can convert streaming media data into single-rate streaming media data, in the embodiments of the present disclosure, a real-time transcoding server closest to a main playback user server is selected according to attribute information of a main playback user in a received streaming media data uploading request, then streaming media data are converted into multi-rate streaming media data by means of the real-time transcoding server, and at last the multi-rate streaming media data are sent to a source server, thereby solving the problem that live videos are difficult to adapt to demands of different player terminals for code rates.

It is to be noted that in allusion to the foregoing apparatus for transcoding a live video, functions of each unit module used in the embodiments of the present disclosure can be implemented through a hardware processor.

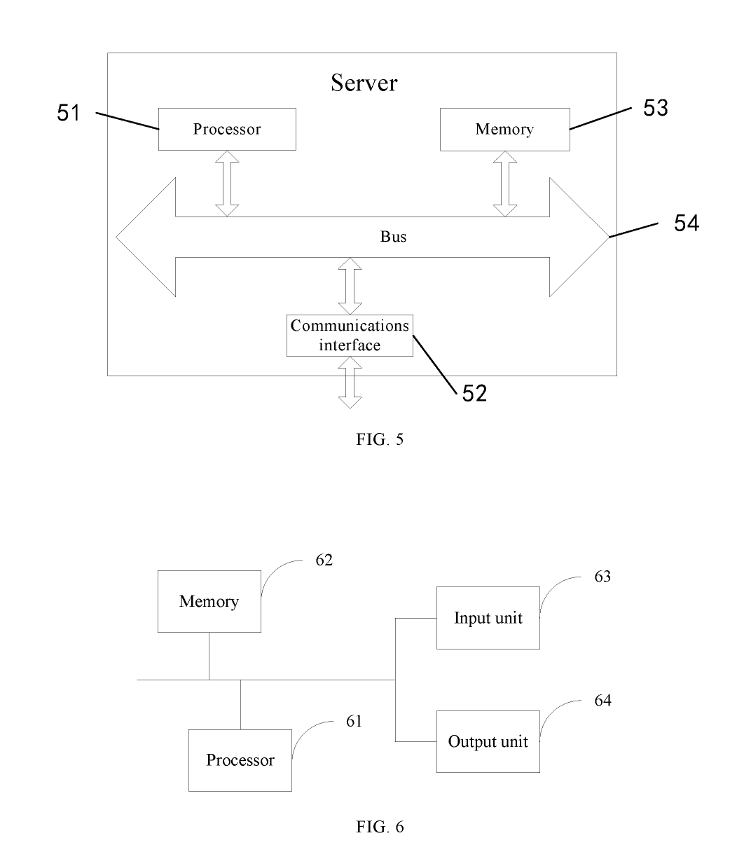

Exemplarily, as shown in FIG. 5, which shows a schematic diagram of an entity structure of a server according to embodiments of the present disclosure, the server can include: a processor 51, a communications interface 52, a memory 53 and a bus 54, where the processor 51, the communications interface 52 and the memory 53 complete communications among each other through the bus 54. The communications interface 52 can be configured to implement information transmission between a server and a client. The processor 51 can invoke a logic instruction in the memory 53 to execute the following method: first of all, a streaming media data uploading request sent by a main playback user is received, where the streaming media data uploading request carries streaming media data and attribute information of the main playback user, then a real-time transcoding server is selected according to the attribute information of the main playback user, the streaming media data are sent to the real-time transcoding server so that the real-time transcoding server converts in real time the streaming media data into multi-rate streaming media data, and the multi-rate streaming media data are sent to a source server, where the real-time transcoding server and the source server are in a distributed deployment.

In addition, when a logic instruction in the foregoing memory 53 can be implemented in the form of a software functional unit and is sold or used as an independent product, the logic instruction can be stored in a computer-readable storage medium. Based on such understanding, the essence of or a part of the technical solutions in the present disclosure (that is, the part making contributions over prior arts) may be embodied as software products. The computer software products may be stored in a storage medium including instructions which enable a computer device (for example, a personal computer, a server or a network device, and so on) to perform whole or a part of the steps in the methods according to various embodiments of the present disclosure. The above mentioned storage medium may include various mediums capable of storing program codes, for example, a USB flash drive, a mobile hard disk drive, a read only memory (ROM), a random access memory (RAM), a magnetic disk or an optical disk, and so on.

Further, an embodiment of the present disclosure further provides a non-transitory computer-readable storage medium storing executable instructions, which can be executed by an electronic device to perform any methods for transcoding a live video mentioned by embodiments of the present disclosure.

FIG. 6 is a block diagram of an electronic device which is configured to perform the methods for transcoding a live video according to an embodiment of the present disclosure. As shown in FIG. 6, the device includes:

one or more processors 61 and memory 62. A processor 61 is showed in FIG. 6 for an example.

Device which is configured to perform the methods for transcoding a live video can also include: input unit 63 and output unit 64.

Processor 61, memory 62, input unit 63 and output unit 64 can be connected by BUS or other methods, and BUS connecting is showed in FIG. 6 for an example.

Memory 62 can be used for storing non-transitory software program, non-transitory computer executable program and modules as a non-transitory computer-readable storage medium, such as corresponding program instructions/modules for the methods for transcoding a live video mentioned by embodiments of the present disclosure (such as shown in FIG. 3, receiving unit 31, selecting unit 32 and sending unit 33). Processor 61 performs kinds of functions and transcoding a live video of the electronic device by executing non-transitory software program, instructions and modules which are stored in memory 62, thereby realizes the methods for transcoding a live video mentioned by embodiments of the present disclosure.

Memory 62 can include program storage area and data storage area, thereby the operating system and applications required by at least one function can be stored in program storage area and data created by using the device for transcoding a live video can be stored in data storage area. Furthermore, memory 62 can include high speed Random-access memory (RAM) or non-volatile memory such as magnetic disk storage device, flash memory device or other non-volatile solid state storage devices. In some embodiments, memory 62 can include long-distance setup memories relative to processor 61, which can communicate with the device for transcoding a live video by networks. The examples of said networks are including but not limited to Internet, Intranet, LAN, mobile Internet and their combinations.

Input unit 63 can be used to receive inputted number, character information and key signals causing user configures and function controls of the device for transcoding a live video. Output unit 64 can include a display screen or a display device.

The said module or modules are stored in memory 62 and perform the methods for transcoding a live video when executed by one or more processors 61.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for transcoding a live video, implemented by a server, comprising:
receiving a streaming media data uploading request sent by a main playback user, wherein the streaming media data uploading request carries streaming media data and attribute information of the main playback user;
selecting a real-time transcoding server according to the attribute information of the main playback user; and
sending the streaming media data to the real-time transcoding server so that the real-time transcoding server converts in real time the streaming media data into multi-rate streaming media data, and sending the multi-rate streaming media data to a source server, wherein the real-time transcoding server and the source server are in a distributed deployment.

2. The method according to claim 1, wherein the attribute information of the main playback user comprises operator information; and
the selecting a real-time transcoding server according to the attribute information of the main playback user comprises:
selecting real-time transcoding servers corresponding to the operator information.

3. The method according to claim 2, wherein the attribute information of the main playback user further comprises location information; and
after selecting real-time transcoding servers corresponding to the operator information, the method further comprises:
extracting real-time transcoding servers that can transcode the location information from the real-time transcoding servers corresponding to the operator information.

4. The method according to claim 3, wherein after extracting real-time transcoding servers that can transcode the location information, the method further comprises:
acquiring load data of the real-time transcoding servers that can transcode the location information; and
screening out real-time transcoding servers whose load data are less than or equal to a preset threshold from the real-time transcoding servers that can transcode the location information.

5. The method according to claim 4, wherein after screening out real-time transcoding servers whose load data are less than or equal to a preset threshold, the method further comprises:
selecting a real-time transcoding server closest to the location information from the real-time transcoding servers whose load data are less than or equal to the preset threshold.

6. The method according to claim 1, wherein when the streaming media data uploading request further carries identification information, the sending the streaming media data to the real-time transcoding server comprises:
sending the streaming media data and the identification information to the real-time transcoding server so that the real-time transcoding server converts in real time the streaming media data into multi-rate streaming media data, and adds the identification information onto the multi-rate streaming media data.

7. A non-transitory computer-readable storage medium storing executable instructions that, when executed by an electronic device, cause the electronic device to:
receive a streaming media data uploading request sent by a main playback user, wherein the streaming media data uploading request carries streaming media data and attribute information of the main playback user;
select a real-time transcoding server according to the attribute information of the main playback user; and
send the streaming media data to the real-time transcoding server so that the real-time transcoding server converts in real time the streaming media data into multi-rate streaming media data, and sending the multi-rate streaming media data to a source server, wherein the real-time transcoding server and the source server are in a distributed deployment.

8. The non-transitory computer-readable storage medium according to claim 7, wherein the attribute information of the main playback user comprises operator information; and
the selecting a real-time transcoding server according to the attribute information of the main playback user comprises:
selecting real-time transcoding servers corresponding to the operator information.

9. The non-transitory computer-readable storage medium according to claim 8, wherein the attribute information of the main playback user further comprises location information; and
after selecting real-time transcoding servers corresponding to the operator information, the executable instructions are executed to cause the electronic device to:
extract real-time transcoding servers that can transcode the location information from the real-time transcoding servers corresponding to the operator information.

10. The non-transitory computer-readable storage medium according to claim 9, wherein after extracting real-time transcoding servers that can transcode the location information, the executable instructions are executed to cause the electronic device to:
acquire load data of the real-time transcoding servers that can transcode the location information; and
screen out real-time transcoding servers whose load data are less than or equal to a preset threshold from the real-time transcoding servers that can transcode the location information.

11. The non-transitory computer-readable storage medium according to claim 10, wherein after screening out real-time transcoding servers whose load data are less than or equal to a preset threshold, the executable instructions are executed to cause the electronic device to:
select a real-time transcoding server closest to the location information from the real-time transcoding servers whose load data are less than or equal to the preset threshold.

12. The non-transitory computer-readable storage medium according to claim 7, wherein when the streaming media data uploading request further carries identification information, the sending the streaming media data to the real-time transcoding server comprises:
sending the streaming media data and the identification information to the real-time transcoding server so that the real-time transcoding server converts in real time the streaming media data into multi-rate streaming media data, and adds the identification information onto the multi-rate streaming media data.

13. An electronic device, comprising:
at least one processor; and
a memory communicably connected with the at least one processor for storing instructions executable by the at least one processor, wherein execution of the instructions by the at least one processor causes the at least one processor to:
receive a streaming media data uploading request sent by a main playback user, wherein the streaming media data uploading request carries streaming media data and attribute information of the main playback user;
select a real-time transcoding server according to the attribute information of the main playback user; and
send the streaming media data to the real-time transcoding server so that the real-time transcoding server converts in real time the streaming media data into multi-rate streaming media data, and sending the multi-rate streaming media data to a source server, wherein the real-time transcoding server and the source server are in a distributed deployment.

14. The electronic device according to claim 13, wherein the attribute information of the main playback user comprises operator information; and
the selecting a real-time transcoding server according to the attribute information of the main playback user comprises:
selecting real-time transcoding servers corresponding to the operator information.

15. The electronic device according to claim 14, wherein the attribute information of the main playback user further comprises location information; and
after selecting real-time transcoding servers corresponding to the operator information, the instructions are executed to cause the at least one processor to:
extract real-time transcoding servers that can transcode the location information from the real-time transcoding servers corresponding to the operator information.

16. The electronic device according to claim 15, wherein after extracting real-time transcoding servers that can transcode the location information, the instructions are executed to cause the at least one processor to:
acquire load data of the real-time transcoding servers that can transcode the location information; and
screen out real-time transcoding servers whose load data are less than or equal to a preset threshold from the real-time transcoding servers that can transcode the location information.

17. The electronic device according to claim 16, wherein after screening out real-time transcoding servers whose load data are less than or equal to a preset threshold, the instructions are executed to cause the at least one processor to:
select a real-time transcoding server closest to the location information from the real-time transcoding servers whose load data are less than or equal to the preset threshold.

18. The electronic device according to claim 13, wherein when the streaming media data uploading request further carries identification information, the sending the streaming media data to the real-time transcoding server comprises:
sending the streaming media data and the identification information to the real-time transcoding server so that the real-time transcoding server converts in real time the streaming media data into multi-rate streaming media data, and adds the identification information onto the multi-rate streaming media data.
